(19) United States
(12) Patent Application Publication
(10) Pub. No.: US 2024/0302560 A1
(43) Pub. Date: Sep. 12, 2024

(54) Ground-Air TEM Transverse Magnetic Polarization Field Detection Method and System, and Forward Modeling Method and Device

(71) Applicants: Nannan ZHOU, Beijing (CN); Guoqiang XUE, Beijing (CN); Kangxin LEI, Beijing (CN)

(72) Inventors: Nannan ZHOU, Beijing (CN); Guoqiang XUE, Beijing (CN); Kangxin LEI, Beijing (CN)

(21) Appl. No.: 18/621,102

(22) Filed: Mar. 29, 2024

(51) Int. Cl. G01V 3/17; G01V 3/38

(52) U.S. Cl. CPC G01V 3/17; G01V 3/38

(57) ABSTRACT

The embodiment of the invention provides a ground-air TEM transverse magnetic polarization field detection method and system, and a forward modeling method and device. The ground-air TEM transverse magnetic polarization field detection method comprises: adopting an umbrella-shaped source as a ground emission source, wherein the umbrella-shaped source is an emission source device comprising a plurality of emission line sources, the lengths of the emission line sources are the same, one end of each emission line source is connected to the center of the umbrella-shaped source, the emission line sources are arranged in an umbrella rib mode, current directions diverge outwards from the center along each emission line source, and included angles between adjacent emission line sources are identical; and using the umbrella-shaped source to detect a ground-air transient electromagnetic field, and obtaining the horizontal magnetic field component data of the umbrella-shaped source, thus realizing the observation of a ground-air TEM transverse magnetic polarization field. The above technology of the invention can cover the shortage of a ground-air TEM in high-resistance target detection.

### TECHNICAL FIELD

The embodiment of the invention relates to the field of electromagnetic detection, and more particularly; the embodiment of the invention relates to a ground-air TEM transverse magnetic polarization field detection method and system, and a forward modeling method and device.

### BACKGROUND ART

Ground-air TEM is a new electromagnetic detection method developed in recent years, which can realize rapid detection of underground electrical structures. Compared with the airborne electromagnetic method, the ground-air TEM has a greater detection depth and signal-to-noise ratio. However, similar to the airborne electromagnetic method, the ground-air TEM can only observe three components of a magnetic field. Whether it is a loop source or ground conductor source, the ground-air TEM observes magnetic field components mainly composed of a transverse polarization field, which to some extent limits the ability of the ground-air TEM to detect high resistance.

### SUMMARY OF THE INVENTION

In this context, the embodiment of the invention is expected to provide a ground-air TEM transverse magnetic polarization field detection method and system, and a forward modeling method and device, so as to at least solve the problem that an existing ground-air TEM has deficiencies in high-resistance target detection.

In a first aspect of the embodiment of the invention, a ground-air TEM transverse magnetic polarization field detection method is provided, comprising: adopting an umbrella-shaped source as a ground emission source, wherein the umbrella-shaped source is an emission source device comprising a plurality of emission line sources, the lengths of the emission line sources are the same, one end of each emission line source is connected to the center of the umbrella-shaped source, the emission line sources are arranged in an umbrella rib mode, current directions diverge outwards from the center along each emission line source, and included angles between adjacent emission line sources are identical; and using the umbrella-shaped source to detect a ground-air transient electromagnetic field, and obtaining the horizontal magnetic field component data of the umbrella-shaped source, thus realizing the observation of a ground-air TEM transverse magnetic polarization field.

Further, the ground-air TEM transverse magnetic polarization field detection method also comprises: performing data inversion by using the horizontal magnetic field component data of the umbrella-shaped source, and identifying underground high-resistance target information according to the data inversion result.

Further, the step of performing data inversion by using the horizontal magnetic field component data of the umbrella-shaped source comprises: using the following function as the target function for data inversion: U=∥∂m∥²+μ⁻¹{∥W_{d}d−W_{d}F(m)∥²−x_{*}²} wherein m=(m₁, m₂, . . . m_{N}) is a model vector, m₁˜m_{N} are model parameters in the model vector, N is the number of models, d=(d₁,d₂, . . . ,d_{M}) is a data vector, d₁-d_{M} are specific data in the data vector, M is the number of data, F is a positive operator, X_{*} is a target fitting residual, ∂ is a roughness matrix, W_{d}=diag(σ₁⁻¹,σ₂⁻¹, . . . ,σ_{M}⁻¹) is an error weighting matrix, σ₁⁻¹˜σM⁻¹ are errors corresponding to the data respectively, and μ is a Lagrange multiplier, and is used for roughness and target fitting residual: according to Taylor's theorem and the idea of local linearization, converting a nonlinear problem into a linear problem according to the following formula: F(m^{k}+Δm)≈F(m^{k})+J(m^{k})Δm; wherein m^{k}+Δm=m^{k+1}, and J(m^{k}) is a Jacobian matrix: solving the regularization least squares problem by the following formula: mₖ₊₁(μ)=[μ∂^{T}∂+(WJₖ)^{T}WJₖ]⁻¹(WJₖ)^{T}W\hat{d}ₖ wherein \hat{d}ₖ=d−F(mₖ)+Jₖmₖ, reducing the fitting residual by linearization search of u; and when the fitting residual is less than a target value, introducing model roughness to finally obtain a smoothest model.

Further, the best observation area for umbrella-shaped source ground-air transient electromagnetic field data is a horizontal magnetic field.

In a second aspect of the embodiment of the invention, a ground-air TEM transverse magnetic polarization field detection system is provided, the ground-air TEM transverse magnetic polarization field detection system comprises a ground emission source, and the ground emission source is an umbrella-shaped source, wherein the umbrella-shaped source is an emission source device comprising a plurality of emission line sources, the lengths of the emission line sources are the same, one end of each emission line source is connected to the center of the umbrella-shaped source, the emission line sources are arranged in an umbrella rib mode, current directions diverge outwards from the center along each emission line source, and included angles between adjacent emission line sources are identical; and the ground-air TEM transverse magnetic polarization field detection system further comprises a processing unit, and the processing unit is suitable for realizing observation of a ground-air TEM transverse magnetic polarization field based on the horizontal magnetic field component data of the umbrella-shaped source when the umbrella-shaped source is used for detecting a ground-air transient electromagnetic field.

Further, the processing unit is also suitable for performing data inversion by using the horizontal magnetic field component data of the umbrella-shaped source, and identifying underground high-resistance target information according to the data inversion result.

Further, the processing unit is suitable for using the following function as the target function for data inversion: U=∥∂m∥²+μ⁻¹{∥W_{d}d−W_{d}F(m)∥²−x_{*}²} wherein m=(m₁, m₂, . . . m_{N}) is a model vector, m₁˜m_{N} are model parameters in the model vector, N is the number of models, d=(d₁,d₂, . . . ,d_{M}) is a data vector, d₁-d_{M} are specific data in the data vector, M is the number of data, F is a positive operator, X_{*} is a target fitting residual, ∂ is a roughness matrix, W_{d}=diag(σ₁⁻¹,σ₂⁻¹, . . . ,σ_{M}⁻¹) is an error weighting matrix, σ₁⁻¹˜σM⁻¹ are errors corresponding to the data respectively, and μ is a Lagrange multiplier, and is used for roughness and target fitting residual: according to Taylor's theorem and the idea of local linearization, converting a nonlinear problem into a linear problem according to the following formula: F(m^{k}+Δm)≈F(m^{k})+J(m^{k})Δm wherein m^{k}+Δm=m^{k+1}, and J(m^{k}) is a Jacobian matrix: solving the regularization least squares problem by the following formula: mₖ₊₁(μ)=[μ∂^{T}∂+(WJₖ)^{T}WJₖ]⁻¹(WJₖ)^{T}W\hat{d}ₖ; wherein \hat{d}ₖ=d−F(mₖ)+Jₖmₖ, reducing the fitting residual by linearization search of u; and when the fitting residual is less than a target value, introducing model roughness to finally obtain a smoothest model.

Further, the best observation area for umbrella-shaped source ground-air transient electromagnetic field data is a horizontal magnetic field.

In a third aspect of the embodiment of the invention, a forward modeling method for umbrella-shaped source ground-air TEM detection is provided, and the forward modeling method comprises: during layered earth surface excitation and air reception, obtaining a magnetic field component generated by excitation of a single grounding conductor source in the x-direction according to the following formulas:

$${H}_{x} = - \frac{I}{4 π} \frac{y}{r} {\int }_{0}^{∞} ( {r}_{TM} + {r}_{TE} ) {e}^{{u}_{0} z} {J}_{1} ( λ r ) d λ {\vert}_{{R}_{1}}^{{R}_{2}} ,$$

$${H}_{y} = - \frac{I}{4 π} \frac{x}{r} {\int }_{0}^{∞} ( {r}_{TM} + {r}_{TE} ) {e}^{{u}_{0} z} {J}_{1} ( λ r ) d λ {\vert}_{{R}_{1}}^{{R}_{2}} - \frac{I}{4 π} {\int }_{- L}^{L} {\int }_{0}^{∞} ( 1 - {r}_{TE} ) {e}^{{u}_{0} z} λ {J}_{0} ( λ r ) d λ {dx}^{′} ,$$

$${H}_{z} = \frac{I}{4 π} {\int }_{- L}^{L} \frac{y}{r} {\int }_{0}^{∞} ( 1 + {r}_{TE} ) {e}^{{u}_{0} z} \frac{{λ}^{2}}{{u}_{0}} {J}_{1} ( λ r ) d λ {dx}^{′} ;$$

for an umbrella-shaped source ground-air transient electromagnetic field, establishing coordinate systems by taking each line source as an X axis and the midpoint of each line source as a source point; obtaining the coordinates of the same measuring point in different coordinate systems through the translation and rotation relation of the coordinate systems; obtaining each component of the magnetic field excited by an umbrella-shaped source by superposition:

$${H}_{xU} = {{\sum }^{10}}_{i = 1} {H}_{xi} = {{\sum }^{10}}_{i = 1} - \frac{I}{4 π} \frac{{y}_{i}}{{r}_{i}} {\int }_{0}^{∞} ( {r}_{TM} + {r}_{TE} ) {e}^{{u}_{0} z} {J}_{1} ( λ {r}_{i} ) d λ {\vert}_{{R}_{i 1}}^{{R}_{i 2}} ,$$

$${H}_{yU} = {{\sum }^{10}}_{i = 1} {H}_{yi} = {{\sum }^{10}}_{i = 1} - \frac{I}{4 π} \frac{{x}_{i}}{{r}_{i}} {\int }_{0}^{∞} ( {r}_{TM} + {r}_{TE} ) {e}^{{u}_{0} z} {J}_{1} ( λ {r}_{i} ) d λ {\vert}_{{R}_{i 1}}^{{R}_{i 2}} - \frac{I}{4 π} {\int }_{- L}^{L} {\int }_{0}^{∞} ( 1 - {r}_{TE} ) {e}^{{u}_{0} z} λ {J}_{0} ( {λr}_{i} ) d λ {dx}_{i}^{′} ,$$

$${H}_{zU} = {{\sum }^{10}}_{i = 1} {H}_{zi} = {{\sum }_{i = 1}}^{10} \frac{I}{4 π} {\int }_{- L}^{L} \frac{{y}_{i}}{{r}_{i}} {\int }_{0}^{∞} ( 1 + {r}_{TE} ) {e}^{{u}_{0} z} \frac{{λ}^{2}}{{u}_{0}} {J}_{1} ( λ {r}_{i} ) d λ {dx}_{i}^{′} ;$$

J₁(λr) and J₀(λr) are first-order and zero-order Bessel functions of the first kind respectively, λ represents the horizontal wavenumber, and rᵢ represents the transceiving distance of a measuring point in the coordinate systems to which different line sources belong; hⱼ represents the thickness of a j<th> layer; \hat{Z}ⱼ represents the impedance of the j<th> layer, ŷⱼ represents the admittance of the j<th> layer, and z represents the height of a receiving point;

$${r}_{TE} = \frac{{Y}_{0} - {\hat{Y}}_{1}}{{Y}_{0} + {\hat{Y}}_{1}}$$

represents the reflection coefficient of electromagnetic waves when an electric field component is incident on a plane,

$${r}_{TM} = \frac{{Z}_{0} - {\hat{Z}}_{1}}{{Z}_{0} + {\hat{Z}}_{1}}$$

represents the reflection coefficient of electromagnetic waves when a vertical magnetic field is incident on the plane,

$${Y}_{0} = \frac{{μ}_{0}}{{\hat{𝓏}}_{0}}$$

represents the intrinsic admittance of free space, Ŷ₁ represents the admittance of the earth surface,

$${Z}_{0} = \frac{{μ}_{0}}{{\hat{y}}_{0}}$$

represents the intrinsic impedance of free space, \hat{Z}₁ represents the impedance of the earth surface (the impedance of the earth surface and admittance are obtained by recursion at the lowest layer), \hat{z}₀=iωμ₀, ŷ₀=iωε₀, ω represents angular frequency, ε₀ represents the dielectric coefficient of underground homogeneous half-space, and μ₀ represents the permeability of the underground homogeneous half-space.

In a fourth aspect of the embodiment of the invention, a forward modeling device for umbrella-shaped source ground-air TEM detection is provided, and the forward modeling device comprises: a first calculation unit, suitable for, during layered earth surface excitation and air reception, obtaining a magnetic field component generated by excitation of a single grounding conductor source in the x-direction according to the following formulas:

$${{H}_{x} = - \frac{I}{4 π} \frac{y}{r} {\int }_{0}^{∞} ( {r}_{TM} + {r}_{TE} ) {e}^{{u}_{0} 𝓏} {J}_{1} ( λ r ) d λ \vert}_{{R}_{1}}^{{R}_{2}} ,$$

$${{H}_{y} = - \frac{I}{4 π} \frac{x}{r} {\int }_{0}^{∞} ( {r}_{TM} + {r}_{TE} ) {e}^{{u}_{0} 𝓏} {J}_{1} ( λ r ) d λ \vert}_{{R}_{1}}^{{R}_{2}} - \frac{I}{4 π} {\int }_{- L}^{L} {\int }_{0}^{∞} ( 1 - {r}_{TE} ) {e}^{{u}_{0} 𝓏} λ {J}_{0} ( λ r ) d λ {dx}^{′} , ?$$

$${H}_{𝓏} = \frac{I}{4 π} {\int }_{- L}^{L} \frac{y}{r} {\int }_{0}^{∞} ( 1 + {r}_{TE} ) {e}^{{u}_{0} 𝓏} \frac{{λ}^{2}}{{u}_{0}} {J}_{1} ( λ r ) d λ {dx}^{′} ;$$

a coordinate transformation unit, suitable for, for an umbrella-shaped source ground-air transient electromagnetic field, establishing coordinate systems by taking each line source as an X axis and the midpoint of each line source as a source point, and obtaining the coordinates of the same measuring point in different coordinate systems through the translation and rotation relation of the coordinate systems; a second calculation unit, suitable for obtaining each component of the magnetic field excited by an umbrella-shaped source by superposition:

$${{H}_{xU} = {\sum }_{i = 1}^{10} {H}_{xi} = {\sum }_{i = 1}^{10} - \frac{I}{4 π} \frac{{y}_{i}}{{r}_{i}} {\int }_{0}^{∞} ( {r}_{TM} + {r}_{TE} ) {e}^{{u}_{0} 𝓏} {J}_{1} ( λ {r}_{i} ) d λ \vert}_{{R}_{i 1}}^{{R}_{i 2}} ,$$

$${{H}_{yU} = {\sum }_{i = 1}^{10} {H}_{yi} = {\sum }_{i = 1}^{10} - \frac{I}{4 π} \frac{{x}_{i}}{{r}_{i}} {\int }_{0}^{∞} ( {r}_{TM} + {r}_{TE} ) {e}^{{u}_{0} 𝓏} {J}_{1} ( λ {r}_{i} ) d λ \vert}_{{R}_{i 1}}^{{R}_{i 2}} - \frac{I}{4 π} {\int }_{- L}^{L} {\int }_{0}^{∞} ( 1 - {r}_{TE} ) {e}^{{u}_{0} 𝓏} λ {J}_{0} ( λ {r}_{i} ) d λ {dx}_{i}^{′} ,$$

$${H}_{𝓏 U} = {\sum }_{i = 1}^{10} {H}_{𝓏 i} = {\sum }_{i = 1}^{10} \frac{I}{4 π} {\int }_{- L}^{L} \frac{{y}_{i}}{{r}_{i}} {\int }_{0}^{∞} ( 1 + {r}_{TE} ) {e}^{{u}_{0} 𝓏} \frac{{λ}^{2}}{{u}_{0}} {J}_{1} ( λ {r}_{i} ) d λ {dx}_{i}^{′} ;$$

J₁(λr) and J₀(λr) are first-order and zero-order Bessel functions of the first kind respectively, λ represents the horizontal wavenumber, and rᵢ represents the transceiving distance of a measuring point in the coordinate systems to which different line sources belong; hⱼ represents the thickness of a j<th> layer; \hat{z}ⱼ represents the impedance of the j<th> layer, ŷⱼ represents the admittance of the j<th> layer, and z represents the height of a receiving point:

$${r}_{TE} = \frac{{Y}_{0} - {\hat{Y}}_{1}}{{Y}_{0} + {\hat{Y}}_{1}}$$

represents the reflection coefficient of electromagnetic waves when an electric field component is incident on a plane,

$${r}_{TM} = \frac{{Z}_{0} - {\hat{Z}}_{1}}{{Z}_{0} + {\hat{Z}}_{1}}$$

represents the reflection coefficient of electromagnetic waves when a vertical magnetic field is incident on the plane,

$${Y}_{0} = \frac{{u}_{0}}{{\hat{𝓏}}_{0}}$$

represents the intrinsic admittance of free space, Ŷ₁ represents the admittance of the earth surface,

$${Z}_{0} = \frac{{u}_{0}}{{\hat{y}}_{0}}$$

represents the intrinsic impedance of free space, \hat{Z}₁ represents the impedance of the earth surface (the impedance of the earth surface and admittance are obtained by recursion at the lowest layer), \hat{z}₀=iωμ₀, ŷ₀=iωε₀, ω represents angular frequency, ε₀ represents the dielectric coefficient of underground homogeneous half-space, and μ₀ represents the permeability of the underground homogeneous half-space.

The ground-air TEM transverse magnetic polarization field detection method and system, and the forward modeling method and device according to the embodiment of the invention can cover the shortage of a ground-air TEM in high-resistance target detection, and the ground-air TEM detection method based on the ground umbrella-shaped emission source is proposed by referring to the detection mode of observing the transverse magnetic polarization field by a circular electric dipole source (CED). Firstly, the distribution characteristics of the ground-air TEM horizontal magnetic field of the umbrella-shaped source and the resolving power on electrical structures are analyzed: then, a data inversion method for horizontal component data is proposed to realize effective identification of underground high-resistance target information; finally, by observing the horizontal magnetic field component of the umbrella-shaped source, the observation of the ground-air TEM transverse magnetic polarization field is realized, and the ability of the ground-air TEM to detect high-resistance targets is improved.

### BRIEF DESCRIPTION OF THE DRAWINGS

The above and other objects, features and advantages of exemplary embodiments of the present invention will become readily understood by reading the following detailed description with reference to the accompanying drawings. In the drawings, several embodiments of the present invention are shown by way of example and not limitation, in which:

FIG. 1 is a flowchart schematically showing one exemplary process of a ground-air TEM transverse magnetic polarization field detection method according to an embodiment of the present invention:

FIG. 2 is a structure block diagram schematically showing one example of a ground-air TEM transverse magnetic polarization field detection system according to an embodiment of the present invention:

FIG. 3 is a schematic diagram showing an umbrella-shaped source ground-air TEM detection device:

FIG. 4 is a schematic diagram showing different source coordinate conversion relationships:

FIGS. 5A-5D are schematic diagrams showing X-direction horizontal magnetic field response distribution:

FIGS. 6A-6D are schematic diagrams showing Y-direction horizontal magnetic field response distribution:

FIGS. 7A-7D are schematic diagrams showing Z-direction horizontal magnetic field response distribution:

FIG. 8A is a schematic diagram showing the root mean square error distribution of a high-resistance target by a single-line source ground-air TEM X-horizontal magnetic field:

FIG. 8B is a schematic diagram showing the root mean square error distribution of a high-resistance target by an umbrella-shaped source ground-air TEM X-horizontal magnetic field:

FIG. 9 is a schematic diagram showing the inversion results of a high-resistivity layer model by a conventional method and umbrella-shaped source ground-air TEM.

In the drawings, the same or corresponding reference numerals refer to the same or corresponding parts

### DETAILED DESCRIPTION OF THE INVENTION

The principle and spirit of the present invention will be described below with reference to several exemplary embodiments. It should be understood that these embodiments are only given to enable those skilled in the art to better understand and further implement the present invention, and are not intended to limit the scope of the present invention in any way. Rather, these embodiments are provided so that this disclosure will be thorough and complete, and the scope of this disclosure will be fully conveyed to those skilled in the art.

The inventor discovered that ground-air TEM is an efficient method for detecting underground good conductor targets. Compared with a frequency domain electromagnetic method which observes the total field of primary and secondary fields, TEM has temporal separability, which can separate the primary field from the secondary field. After an excitation field source is turned off, the pure secondary field is observed. The coupling between an observation signal and an underground electrical structure is better than other methods, and it is widely used in the fields of metal mineral, coal resources, geothermy, engineering survey, etc. In some special areas such as rivers, lakes, land-ocean interaction regions, and marshes, ground reception is difficult. The ground-air TEM uses ground emission and air reception to realize effective observation of the above areas. At the same time, the air reception mode can greatly improve the efficiency of data acquisition.

Based on the nature of an excitation field source, there are magnetic source (loop source) ground-air TEM and electrical source (ground conductor source) ground-air TEM. The magnetic source method uses a loop source on the ground to excite an electromagnetic field and observes the vertical magnetic field component in the air, which is sensitive to good conductors, and is one of the most important methods for coalfield hydrogeology exploration and for detecting good conductors such as groundwater. The electric source TEM uses long grounded wires to excite current underground, and the main observation components are vertical magnetic field and horizontal magnetic field. Different from the magnetic source TEM, the electrical source TEM can observe the horizontal magnetic field and has certain resolving power for a high-resistance body:

In addition, the inventor found that magnetic field observation based on the transverse polarization field affects the detection effect on high-resistance targets. The difference in resolving power of TEM to good conductors/high-resistance bodies is analyzed based on the polarization mode of the electromagnetic field. Whether it is magnetic source TEM or electrical source TEM, the best way to understand the difference between the two sources is the division of the polarization fields generated by the sources. The physical and mathematical background of layered earth TEM sounding can be analyzed by describing the transverse electric (TE)-transverse magnetic (TM) dual polarization mode of the electromagnetic field, and the electromagnetic field is regarded as a mixture of a transverse polarization field and a transverse magnetic polarization field. The transverse electric polarization field and the transverse magnetic polarization field show difference in terms of the interaction mode with geological bodies and the vortex current form, and this difference is especially critical in TEM sounding.

The magnetic source TEM only generates horizontal current, and the excited electromagnetic field only includes a transverse electric polarization field. Therefore, the magnetic source TEM is only sensitive to good conductors and has poor resolving power on high-resistance bodies. The electric source TEM generates horizontal current and vertical current underground, and the excited electromagnetic field includes a transverse magnetic polarization field and a transverse electric polarization field. The ground-air TEM only observes magnetic field quantities. The vertical magnetic field (Hz) is the transverse electric polarization field, and the horizontal magnetic fields (Hx, Hy) are the mixture of the transverse electric polarization field and the transverse magnetic polarization field, which improves the ability of the TEM to detect high-resistance bodies to a certain extent, but the resolving power is still limited, which is related to the dominance of the transverse electric polarization field in the horizontal magnetic field.

The resolving power of the transverse magnetic polarization field on high-resistance bodies is much better than that of the transverse electric polarization field. In order to take advantage of the sensitivity of the transverse magnetic polarization field to high resistance, the transverse electric polarization field needs to be removed. This process can be completed through analysis, but it is difficult to extract the actual data. Therefore, the conventional ground-air magnetic source and electrical source TEMs are mainly detection methods based on transverse electric polarization field observation, which restricts the resolving power of TEM on high-resistance bodies.

It is to be understood herein that the number of any element in the drawings is exemplary and not limiting, and any nomenclature is used for distinction only and does not have any limiting meaning. The principle and spirit of the present invention will be explained in detail below with reference to several representative embodiments of the present invention.

### Exemplary Method 1

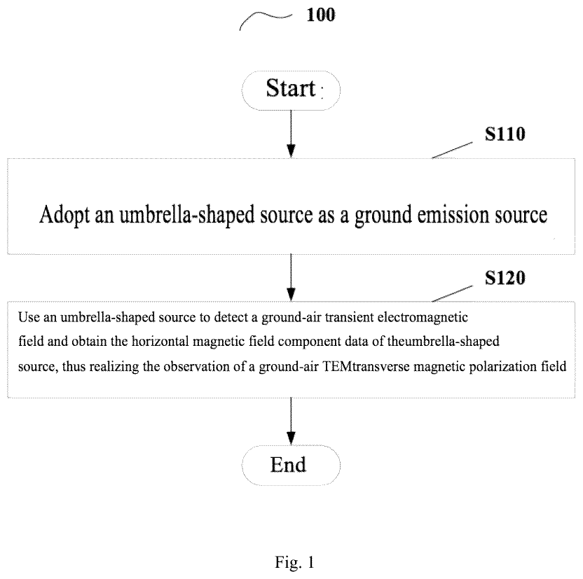

A ground-air TEM transverse magnetic polarization field detection method according to an exemplary embodiment of the present invention will be described below with reference to FIG. 1. FIG. 1 schematically shows one exemplary process flow 100 of the ground-air TEM transverse magnetic polarization field detection method according to an embodiment of the present invention. As shown in FIG. 1, the process flow 100 starts with S110.

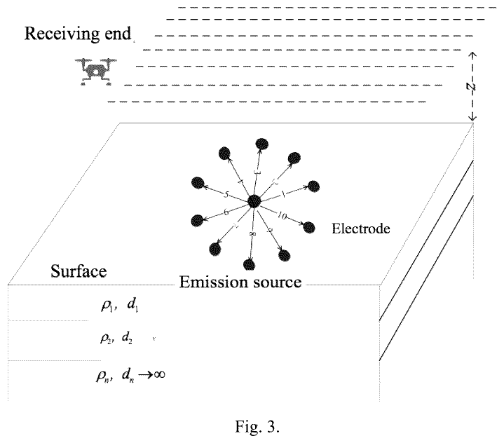

In S110, adopting an umbrella-shaped source as a ground emission source, wherein the umbrella-shaped source is an emission source device comprising a plurality of emission line sources (as shown in FIG. 3 to be described later), the lengths of the emission line sources are the same, one end of each emission line source is connected to the center of the umbrella-shaped source, the emission line sources are arranged in an umbrella rib mode, current directions diverge outwards from the center along each emission line source, and included angles between adjacent emission line sources are identical.

In S120, using the umbrella-shaped source to detect a ground-air transient electromagnetic field, and obtaining the horizontal magnetic field component data of the umbrella-shaped source, thus realizing the observation of a ground-air TEM transverse magnetic polarization field.

As an example, the the ground-air TEM transverse magnetic polarization field detection method may further comprise the following steps: performing data inversion by using the horizontal magnetic field component data of the umbrella-shaped source, and identifying underground high-resistance target information according to the data inversion result.

As an example, the step of performing data inversion by using the horizontal magnetic field component data of the umbrella-shaped source can be realized, for example, in the following manner: using the following function as the target function for data inversion:

$$U = {‖ \partial m ‖}^{2} + {μ}^{- 1} \{ {‖ {W}_{d} d - {W}_{d} F ( m ) ‖}^{2} - {χ}_{*}^{2} \} ,$$

wherein m=(m₁, m₂, . . . m_{N}) is a model vector, m₁˜m_{N} are model parameters in the model vector, N is the number of models, d=(d₁,d₂, . . . ,d_{M}) is a data vector, d₁-d_{M} are specific data in the data vector, M is the number of data, F is a positive operator, X_{*} is a target fitting residual, ∂ is a roughness matrix, W_{d}=diag(σ₁⁻¹,σ₂⁻¹, . . . , σ_{M}⁻¹) is an error weighting matrix, σᵣ⁻¹˜σ_{M}⁻¹ are errors corresponding to the data respectively, and μ is a Lagrange multiplier, and is used for roughness and target fitting residual;

according to Taylor's theorem and the idea of local linearization, converting a nonlinear problem into a linear problem according to the following formula:

$$F ( {m}^{k} + Δ m ) \approx F ( {m}^{k} ) J ( {m}^{k} ) Δ m ;$$

wherein m^{k}+Δm=m^{k+1}, and J(m^{k}) is a Jacobian matrix;
solving the regularization least squares problem by the following formula:

$${m}_{k + 1} ( u ) = {[ μ {\partial }^{T} \partial + {( {WJ}_{k} )}^{T} {WJ}_{k} ]}^{- 1} {( {WJ}_{k} )}^{T} W {\hat{d}}_{k} ;$$

wherein \hat{d}ₓ=d−F(mₖ)+Jₖmₖ.

reducing the fitting residual by linearization search of u; and when the fitting residual is less than a target value, introducing model roughness to finally obtain a smoothest model.

Further, as an example, the best observation area for umbrella-shaped source ground-air transient electromagnetic field data is a horizontal magnetic field.

### Exemplary Method 2

An example of a forward modeling method for umbrella-shaped source ground-air TEM detection according to an exemplary embodiment of the present invention is described below.

During layered earth surface excitation and air reception, obtaining a magnetic field component generated by excitation of a single grounding conductor source in the x-direction according to the following formulas:

$${{H}_{x} = - \frac{I}{4 π} \frac{y}{r} {\int }_{0}^{∞} ( {r}_{TM} + {r}_{TE} ) {e}^{{u}_{0} 𝓏} {J}_{1} ( λ r ) d λ \vert}_{{R}_{1}}^{{R}_{2}} ,$$

$${{H}_{y} = - \frac{I}{4 π} \frac{x}{r} {\int }_{0}^{∞} ( {r}_{TM} + {r}_{TE} ) {e}^{{u}_{0} 𝓏} {J}_{1} ( λ r ) d λ \vert}_{{R}_{1}}^{{R}_{2}} - \frac{I}{4 π} {\int }_{- L}^{L} {\int }_{0}^{∞} ( 1 - {r}_{TE} ) {e}^{{u}_{0} 𝓏} λ {J}_{0} ( λ r ) d λ {dx}^{′} ,$$

$${H}_{𝓏} = \frac{I}{4 π} {\int }_{- L}^{L} \frac{y}{r} {\int }_{0}^{∞} ( 1 + {r}_{TE} ) {e}^{{u}_{0} 𝓏} \frac{{λ}^{2}}{{u}_{0}} {J}_{1} ( λ r ) d λ {dx}^{′} ;$$

for an umbrella-shaped source ground-air transient electromagnetic field, establishing coordinate systems by taking each line source as an X axis and the midpoint of each line source as a source point;
obtaining the coordinates of the same measuring point in different coordinate systems through the translation and rotation relation of the coordinate systems;

obtaining each component of the magnetic field excited by an umbrella-shaped source by superposition:

$${{H}_{xU} = {\sum }_{i = 1}^{10} {H}_{xi} = {\sum }_{i = 1}^{10} - \frac{I}{4 π} \frac{{y}_{i}}{{r}_{i}} {\int }_{0}^{∞} ( {r}_{TM} + {r}_{TE} ) {e}^{{u}_{0} 𝓏} {J}_{1} ( λ {r}_{i} ) d λ \vert}_{{R}_{i 1}}^{{R}_{i 2}} ;$$

$${{H}_{yU} = {\sum }_{i = 1}^{10} {H}_{yi} = {\sum }_{i = 1}^{10} - \frac{I}{4 π} \frac{{x}_{i}}{{r}_{i}} {\int }_{0}^{∞} ( {r}_{TM} + {r}_{TE} ) {e}^{{u}_{0} 𝓏} {J}_{1} ( λ {r}_{i} ) d λ \vert}_{{R}_{i 1}}^{{R}_{i 2}} - \frac{I}{4 π} {\int }_{- L}^{L} {\int }_{0}^{∞} ( 1 - {r}_{TE} ) {e}^{{u}_{0} 𝓏} λ {J}_{0} ( λ {r}_{i} ) d λ {dx}_{i}^{′} ;$$

$${H}_{𝓏 U} = {\sum }_{i = 1}^{10} {H}_{𝓏 i} = {\sum }_{i = 1}^{10} \frac{I}{4 π} {\int }_{- L}^{L} \frac{{y}_{i}}{{r}_{i}} {\int }_{0}^{∞} ( 1 + {r}_{TE} ) {e}^{{u}_{0} 𝓏} \frac{{λ}^{2}}{{u}_{0}} {J}_{1} ( λ {r}_{i} ) d λ {dx}_{i}^{′} ;$$

J₁(λr) and J₀(λr) are first-order and zero-order Bessel functions of the first kind respectively, λ represents the horizontal wavenumber, and rᵢ represents the transceiving distance of a measuring point in the coordinate systems to which different line sources belong; hⱼ represents the thickness of a j<th> layer; \hat{z}ⱼ represents the impedance of the j<th> layer, ŷⱼ represents the admittance of the j<th> layer, and z represents the height of a receiving point;

$${r}_{TE} = \frac{{Y}_{0} - {\hat{Y}}_{1}}{{Y}_{0} + {\hat{Y}}_{1}}$$

represents the reflection coefficient of electromagnetic waves when an electric field component is incident on a plane,

$${r}_{TM} = \frac{{Z}_{0} - {\hat{Z}}_{1}}{{Z}_{0} + {\hat{Z}}_{1}}$$

represents the reflection coefficient of electromagnetic waves when a vertical magnetic field is incident on the plane,

$${Y}_{0} = \frac{{u}_{0}}{{\hat{𝓏}}_{0}}$$

represents the intrinsic admittance of free space, Ŷ₁ represents the admittance of the earth surface,

$${Z}_{0} = \frac{{u}_{0}}{{\hat{y}}_{0}}$$

represents the intrinsic impedance of free space, \hat{Z}₁ represents the impedance of the earth surface (the impedance of the earth surface and admittance are obtained by recursion at the lowest layer), \hat{z}₀=iωμ₀, y₀=iωε₀, ω represents angular frequency, ε₀ represents the dielectric coefficient of underground homogeneous half-space, and μ₀ represents the permeability of the underground homogeneous half-space.

### Exemplary System

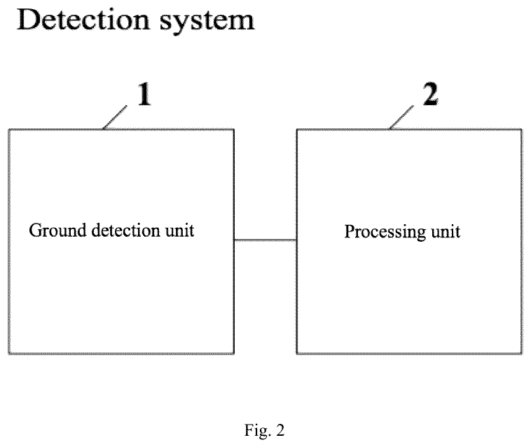

After introducing the ground-air TEM transverse magnetic polarization field detection method and the forward modeling method for umbrella-shaped source ground-air TEM detection according to an exemplary embodiment of the present invention, next, the ground-air TEM transverse magnetic polarization field detection system according to an exemplary embodiment of the present invention will be described with reference to FIG. 2.

Referring to FIG. 2, which schematically shows a structure diagram of a ground-air TEM transverse magnetic polarization field detection system according to an embodiment of the present invention. As shown in FIG. 2, the ground-air TEM transverse magnetic polarization field detection system comprises a ground detection unit 1 and a processing unit 2, wherein the ground detection unit 1 comprises a ground emission source (emission end as shown in FIG. 3) and a receiving end.

The ground emission source is an umbrella-shaped source, wherein the umbrella-shaped source is an emission source device comprising a plurality of emission line sources, the lengths of the emission line sources are the same, one end of each emission line source is connected to the center of the umbrella-shaped source, the emission line sources are arranged in an umbrella rib mode, current directions diverge outwards from the center along each emission line source, and included angles between adjacent emission line sources are identical.

The processing unit 2 is suitable for, when using the umbrella-shaped source to detect a ground-air transient electromagnetic field, realizing the observation of a ground-air TEM transverse magnetic polarization field based on the horizontal magnetic field component data of the umbrella-shaped source.

As an example, the processing unit 2 may perform data inversion by using the horizontal magnetic field component data of the umbrella-shaped source, and identify underground high-resistance target information according to the data inversion result.

As an example, the processing unit 2 may use the following function as the target function for data inversion:

$$U = {‖ \partial m ‖}^{2} + {μ}^{- 1} \{ {‖ {W}_{d} d - {W}_{d} F ( m ) ‖}^{2} - {χ}_{*}^{2} \} ,$$

wherein m=(m₁, m₂, . . . m_{N}) is a model vector, m1˜mN are model parameters in the model vector, N is the number of models, d=(d₁,d₂, . . . ,d_{M}) is a data vector, d₁-d_{M} are specific data in the data vector, M is the number of data, F is a positive operator, X_{*} is a target fitting residual, ∂ is a roughness matrix, W_{d}=diag(σ₁⁻¹,σ₂⁻¹, . . . , σ_{M}⁻¹) is an error weighting matrix, σ₁⁻¹˜σ_{M}⁻¹ are errors corresponding to the data respectively, and μ is a Lagrange multiplier, and is used for roughness and target fitting residual;
according to Taylor's theorem and the idea of local linearization, converting a nonlinear problem into a linear problem according to the following formula:

$$F ( {m}^{k} + Δ m ) \approx F ( {m}^{k} ) + J ( {m}^{k} ) Δ m ;$$

wherein m^{k}+Δm=m^{k+1} and J(m^{k}) is a Jacobian matrix;
solving the regularization least squares problem by the following formula:

$${m}_{k + 1} ( μ ) = {[ μ {\partial }^{T} \partial + {( {WJ}_{k} )}^{T} {WJ}_{k} ]}^{- 1} {( {WJ}_{k} )}^{T} W {\hat{d}}_{k} ;$$

wherein \hat{d}ₖ=d−F(mₖ)+Jₖmₖ.
reducing the fitting residual by linearization search of u; and when the fitting residual is less than a target value, introducing model roughness to finally obtain a smoothest model.

As an example, the best observation area for umbrella-shaped source ground-air transient electromagnetic field data is a horizontal magnetic field.

### Exemplary Device

An example of a forward modeling device for umbrella-shaped source ground-air TEM detection according to the present invention is described below.

The forward modeling device comprises a first calculation unit, a coordinate transformation unit and a second calculation unit.

The first calculation unit is suitable for, during layered earth surface excitation and air reception, obtaining a magnetic field component generated by excitation of a single grounding conductor source in the x-direction according to the following formulas:

$${H}_{x} = - \frac{I}{4 π} \frac{y}{r} {\int }_{0}^{∞} ( {r}_{TM} + {r}_{TE} ) {e}^{{u}_{0} 𝓏} {J}_{1} ( λ r ) d λ {\vert}_{{R}_{1}}^{{R}_{2}} ,$$

$${H}_{y} = - \frac{I}{4 π} \frac{x}{r} {\int }_{0}^{∞} ( {r}_{TM} + {r}_{TE} ) {e}^{{u}_{0} 𝓏} {J}_{1} ( λ r ) d λ {\vert}_{{R}_{1}}^{{R}_{2}} - \frac{I}{4 π} {\int }_{- L}^{L} {\int }_{0}^{∞} ( 1 - {r}_{TE} ) {e}^{{u}_{0} 𝓏} λ {J}_{0} ( λ r ) d λ {dx}^{′} ,$$

$${H}_{𝓏} = \frac{I}{4 π} {\int }_{- L}^{L} \frac{y}{r} {\int }_{0}^{∞} ( 1 + {r}_{TE} ) {e}^{{u}_{0} 𝓏} \frac{{λ}^{2}}{{u}_{0}} {J}_{1} ( λ r ) d λ {dx}^{′} ;$$

the coordinate transformation unit is suitable for, for an umbrella-shaped source ground-air transient electromagnetic field, establishing coordinate systems by taking each line source as an X axis and the midpoint of each line source as a source point, and obtaining the coordinates of the same measuring point in different coordinate systems through the translation and rotation relation of the coordinate systems;
and the second calculation unit is suitable for obtaining each component of the magnetic field excited by an umbrella-shaped source by superposition:

$${H}_{xU} = {\sum }_{i = 1}^{10} {H}_{xi} = {\sum }_{i = 1}^{10} - \frac{I}{4 π} \frac{{y}_{i}}{{r}_{i}} {\int }_{0}^{∞} ( {r}_{TM} + {r}_{TE} ) {e}^{{u}_{0} 𝓏} {J}_{1} ( λ {r}_{i} ) d λ {\vert}_{{R}_{i 1}}^{{R}_{i 2}} ,$$

$${H}_{yU} = {\sum }_{i = 1}^{10} {H}_{yi} = {\sum }_{i = 1}^{10} - \frac{I}{4 π} \frac{{x}_{i}}{{r}_{i}} {\int }_{0}^{∞} ( {r}_{TM} + {r}_{TE} ) {e}^{{u}_{0} 𝓏} {J}_{1} ( λ {r}_{i} ) d λ {\vert}_{{R}_{1}}^{{R}_{2}} - \frac{I}{4 π} {\int }_{- L}^{L} {\int }_{0}^{∞} ( 1 - {r}_{TE} ) {e}^{{u}_{0} 𝓏} λ {J}_{0} ( λ {r}_{i} ) d λ {dx}_{i}^{′} ,$$

$${H}_{𝓏 U} = {\sum }_{i = 1}^{10} {H}_{𝓏 i} = {\sum }_{i = 1}^{10} \frac{I}{4 π} {\int }_{- L}^{L} \frac{{y}_{i}}{{r}_{i}} {\int }_{0}^{∞} ( 1 + {r}_{TE} ) {e}^{{u}_{0} 𝓏} \frac{{λ}^{2}}{{u}_{0}} {J}_{1} ( λ {r}_{i} ) d λ {dx}_{i}^{′} ;$$

J₁(λr) and J₀(λr) are first-order and zero-order Bessel functions of the first kind respectively, λ represents the horizontal wavenumber, and rᵢ represents the transceiving distance of a measuring point in the coordinate systems to which different line sources belong; z represents the height of a receiving point;

$${r}_{TE} = \frac{{Y}_{0} - {\hat{Y}}_{1}}{{Y}_{0} + {\hat{Y}}_{1}}$$

represents the reflection coefficient of electromagnetic waves when an electric field component is incident on a plane,

$${r}_{TM} = \frac{{Z}_{0} - {\hat{Z}}_{1}}{{Z}_{0} + {\hat{Z}}_{1}}$$

represents the reflection coefficient of electromagnetic waves when a vertical magnetic field is incident on the plane,

$${Y}_{0} = \frac{{u}_{0}}{{\hat{𝓏}}_{0}}$$

represents the intrinsic admittance of free space, Ŷ₁ represents the admittance of the earth surface,

$${Z}_{0} = \frac{{u}_{0}}{{\hat{y}}_{0}}$$

represents the intrinsic impedance of free space, \hat{Z}₁ represents the impedance of the earth surface (the impedance of the earth surface and admittance are obtained by recursion at the lowest layer), \hat{z}₀=iωμ₀, y₀=iωε₀, ω represents angular frequency, ε₀ represents the dielectric coefficient of underground homogeneous half-space, and μ₀ represents the permeability of the underground homogeneous half-space.

### Preferred Embodiment

Next, a preferred embodiment of the ground-air TEM transverse magnetic polarization field detection method of the present invention will be described with reference to FIGS. 3-9.

FIG. 3 shows an umbrella-shaped source ground-air TEM detection device as an example of the umbrella-shaped ground emission source (i.e., umbrella-shaped source) in this embodiment.

Vertical electric lead (VEL), vertical electric dipole source (VED) and circular electric dipole source (CED) can excite vertical current and transverse magnetic polarization field, thus realizing transverse magnetic polarization field detection. Currently, they are mainly used in marine electromagnetic exploration. However, it is difficult to deploy VEL and VED devices on land. The CED mode provides the possibility for ground-air TEM transverse magnetic polarization field to detect high-resistance targets. An umbrella-type grounded source airborne TEM (UGATEM) is proposed. The ground emission source is arranged in the form of umbrella ribs. The ribs of the umbrella are distributed symmetrically about a source, for example, the umbrella may comprise an even number of ribs, such as 8, 10 or 16. FIG. 3 shows the emission source device with 10 line sources (ribs). The lengths of the emission sources are the same, current directions diverge to various directions from the center, and included angles between adjacent emission sources are identical. An umbrella-shaped source ground-air TEM forward modeling process in this embodiment is described below.

During layered earth surface excitation and air reception, the expressions of magnetic field components generated by excitation of a single grounding conductor source in the x-direction are shown in Formulas 11-13.

$${H}_{x} = - \frac{I}{4 π} \frac{y}{r} {\int }_{0}^{∞} ( {r}_{TM} + {r}_{TE} ) {e}^{{u}_{0} 𝓏} {J}_{1} ( λ r ) d λ {\vert}_{{R}_{1}}^{{R}_{2}} \qquad Formula 11$$

$${H}_{y} = - \frac{I}{4 π} \frac{x}{r} {\int }_{0}^{∞} ( {r}_{TM} + {r}_{TE} ) {e}^{{u}_{0} 𝓏} {J}_{1} ( λ r ) d λ {\vert}_{{R}_{1}}^{{R}_{2}} - \frac{I}{4 π} {\int }_{- L}^{L} {\int }_{0}^{∞} ( 1 - {r}_{TE} ) {e}^{{u}_{0} 𝓏} λ {J}_{0} ( λ r ) d λ {dx}^{′} \qquad Formula 12$$

$${H}_{𝓏} = \frac{I}{4 π} {\int }_{- L}^{L} \frac{y}{r} {\int }_{0}^{∞} ( 1 + {r}_{TE} ) {e}^{{u}_{0} 𝓏} \frac{{λ}^{2}}{{u}_{0}} {J}_{1} ( λ r ) d λ {dx}^{′} \qquad Formula 13$$

wherein Hx, Hy and Hz are x-,y-, z-direction magnetic fields generated by excitation of the emission source, x and y are coordinates of a measuring point, r is the distance from the measuring point to a source point, I is emission current, e is an exponential function, u₀ is the vertical wave number of the earth surface, R₁ and R₂ are the distance from a ground electrode to the measuring point, L is half of the source length, and x′ is an x-direction integral variable.

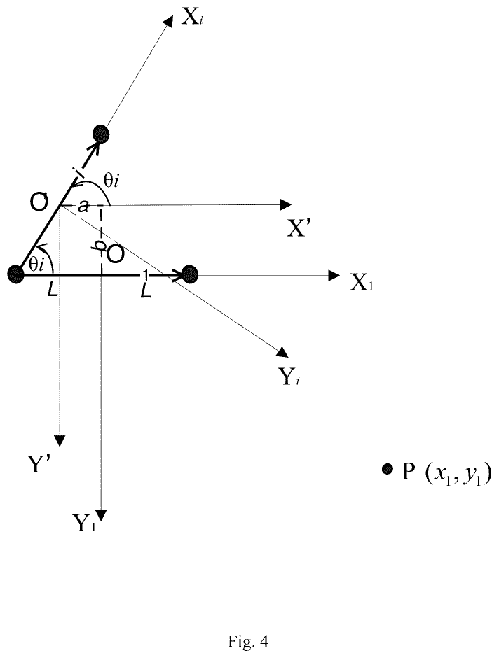

For an umbrella-shaped source ground-air transient electromagnetic field, the solution of the response needs to be obtained by superposing the responses of various line sources, coordinate systems are established by taking each line source as an X axis and the midpoint of each line source as a source point, and FIG. 4 shows different source coordinate conversion relationships, wherein i represents the i<th> source, a=L−Lcos θᵢ, b=Lsin θᵢ, θi represents the rotation angle of the i<th> source relative to the source 1, X₁ and Y₁ respectively represent the x and y axes of the XᵢO′Yᵢ coordinate system, Xᵢ and Yᵢ respectively represent the x and y axes of the XᵢO′Yᵢ coordinate system, X′ and Y′ respectively represent the x and y axes of the X′O′Y′ coordinate system, and O and O′ respectively represent the coordinate origins of the coordinate systems. “1” on the arrow in FIG. 4 indicates the source 1, and the coordinates of other line sources are rotated with respect to the coordinate system in which the source 1 is located.

The coordinates of the same measuring point P(x₁, y₁) in different coordinate systems are obtained through the translation and rotation relation of the coordinate systems:

(a) the coordinate system X₁OY₁ is translated to XO′Y′, and the coordinate transformation is shown in Formulas 21 and 22.

$${x}^{′} = {x}_{1} + a \qquad Formula 21$$

$${y}^{′} = {y}_{1} + b \qquad Formula 22$$

wherein a=L−Lcos θᵢ, b=Lsin θᵢ, x′ and y′ represent the coordinates of the measuring point in the X′O′Y′ coordinate system, and x₁ and y₁ represent the coordinates of the measuring point in the X₁OY₁ coordinate system.

In this way, Formulas 31-33 can be obtained by superposing the components of the magnetic field excited by the umbrella-shaped source.

$${H}_{xU} = {\sum }_{i = 1}^{10} {H}_{xi} = {\sum }_{i = 1}^{10} - \frac{I}{4 π} \frac{{y}_{i}}{{r}_{i}} {\int }_{0}^{∞} ( {r}_{TM} + {r}_{TE} ) {e}^{{u}_{0} 𝓏} {J}_{1} ( λ {r}_{i} ) d λ {\vert}_{{R}_{i 1}}^{{R}_{i 2}} \qquad Formula 31$$

$${H}_{yU} = {\sum }_{i = 1}^{10} {H}_{yi} = {\sum }_{i = 1}^{10} - \frac{I}{4 π} \frac{{x}_{i}}{{r}_{i}} {\int }_{0}^{∞} ( {r}_{TM} + {r}_{TE} ) {e}^{{u}_{0} 𝓏} {J}_{1} ( λ {r}_{i} ) d λ {\vert}_{{R}_{1}}^{{R}_{2}} - \frac{I}{4 π} {\int }_{- L}^{L} {\int }_{0}^{∞} ( 1 - {r}_{TE} ) {e}^{{u}_{0} 𝓏} λ {J}_{0} ( λ {r}_{i} ) d λ {dx}_{i}^{′} \qquad Formula 32$$

$${H}_{𝓏 U} = {\sum }_{i = 1}^{10} {H}_{𝓏 i} = {\sum }_{i = 1}^{10} \frac{I}{4 π} {\int }_{- L}^{L} \frac{{y}_{i}}{{r}_{i}} {\int }_{0}^{∞} ( 1 + {r}_{TE} ) {e}^{{u}_{0} 𝓏} \frac{{λ}^{2}}{{u}_{0}} {J}_{1} ( λ {r}_{i} ) d λ {dx}_{i}^{′} \qquad Formula 33$$

wherein Hₓᵤ, H_{yu} and H_{zu} are the x-,y-,z-direction magnetic fields generated by the excitation of a new emission source, Hₓᵢ, H_{yi} and H_{zi} represent the x-,y-,z-direction magnetic fields generated by the excitation of the i<th> source, xᵢ, yᵢ, Rᵢ₁ and Rᵢ₂ respectively represent the distances between two grounding electrodes of the i<th> source and the measuring point when the measuring point is at the X and Y coordinates in the i<th> source, J₀ represents the zero-order Bessel function of the first kind, and xᵢ′ represents the integration variable in the i<th> source.

J₁(λr) and J₀(λr) are first-order and zero-order Bessel functions of the first kind respectively, λ represents the horizontal wavenumber, and rᵢ represents the transceiving distance of the measuring point in the coordinate systems to which different line sources belong: z represents the height of a receiving point:

$${r}_{TE} = \frac{{Y}_{0} - {\hat{Y}}_{1}}{{Y}_{0} + {\hat{Y}}_{1}}$$

represents the reflection coefficient of electromagnetic waves when an electric field component is incident on a plane,

$${r}_{TM} = \frac{{Z}_{0} - {\hat{Z}}_{1}}{{Z}_{0} + {\hat{Z}}_{1}}$$

represents the reflection coefficient of electromagnetic waves when a vertical magnetic field is incident on the plane, Y₀ represents the intrinsic admittance of free space, Ŷ₁ represents the admittance of the earth surface, Z₀ represents the intrinsic impedance of free space, and \hat{Z}₁ represents the impedance of the earth surface (the impedance of the earth surface and admittance are obtained by recursion at the lowest layer).

The best observation area for umbrella-shaped source ground-air TEM in this embodiment is described below.

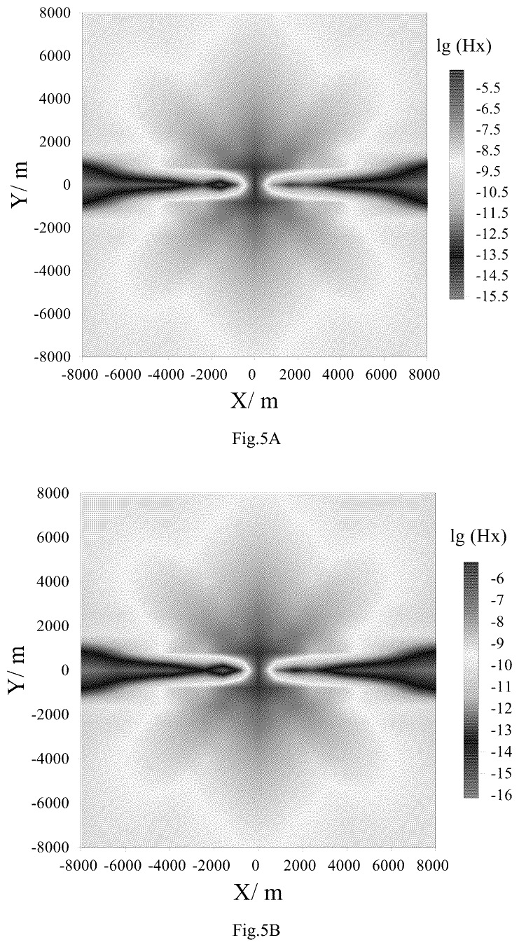

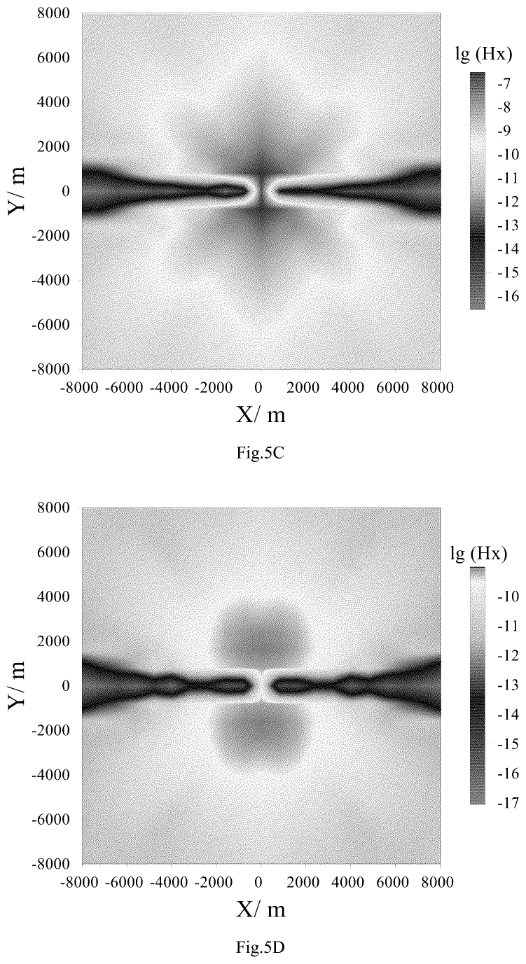

First, the response distribution characteristics of umbrella-shaped source ground-air TEM will be described with reference to FIGS. 5A-5D, 6A-6D and 7A-7D.

Taking 8 line sources as an example, the included angle between adjacent line sources is 45 degrees, the length of each line source is 500 meters, and emission current is 10 A. Taking K-type model as an example, the response of the umbrella-shaped source ground-air transient magnetic field is analyzed, and the height of the receiving point is 30 meters. The geoelectric parameters of the K model are:

$${ρ}_{1} = 100 Ω \cdot m , \qquad {d}_{1} = 300 m ; {ρ}_{2} = 1000 Ω \cdot m , \qquad {d}_{2} = 100 m ; \qquad {ρ}_{3} = 200 Ω \cdot m$$

wherein p₁, d₁, p₂, d₂ and p₃ respectively represent the resistivity of a first layer, the thickness of the first layer, the resistivity of a second layer, the thickness of the second layer and the resistivity of a third layer.

With a source center as the origin of coordinates and the line source 1 as the x axis, the plane distribution of three components of the magnetic field at different time points is obtained through calculation, as shown in FIGS. 5A-7D, wherein lg(Hx) represents the logarithm of the horizontal magnetic field.

FIGS. 5A-5D show the horizontal magnetic field response distribution in the X-direction. FIG. 5A corresponds to 10⁻⁵s, FIG. 5B corresponds to 10⁻⁴s, FIG. 5C corresponds to 10⁻³s, and FIG. 5D corresponds to 10⁻²s. As shown in FIGS. 5A-5D, the horizontal magnetic field in the X-direction is distributed symmetrically, and the response values in the x-axis and the extension direction are much lower than those in other directions.

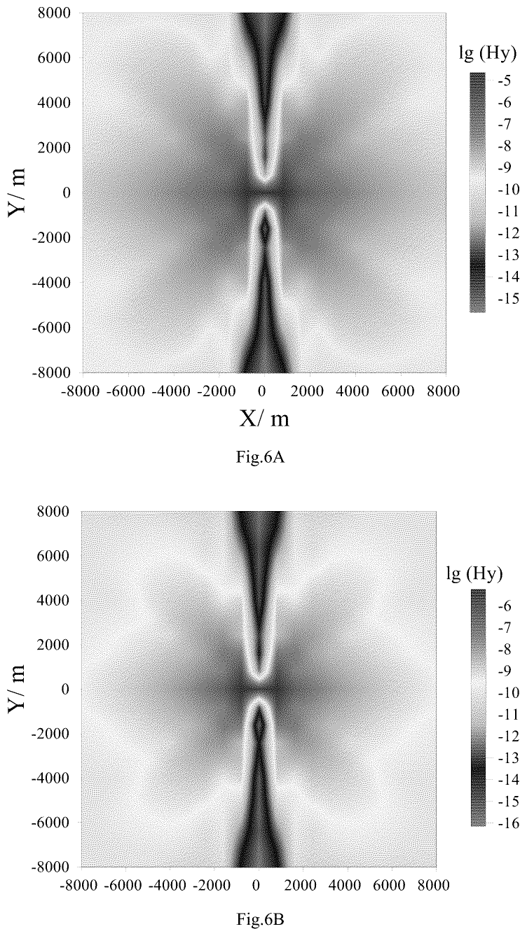

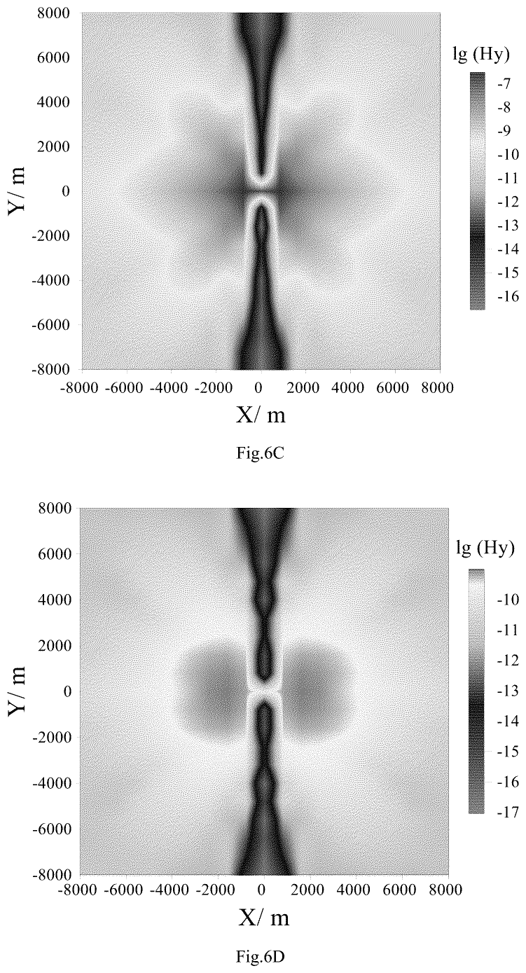

FIGS. 6A-6D show the horizontal magnetic field response distribution in the Y-direction. FIG. 6A corresponds to 10⁻⁵s, FIG. 6B corresponds to 10⁻⁴s, FIG. 6C corresponds to 10⁻³s, and FIG. 6D corresponds to 10⁻²s. As shown in FIGS. 6A-6D, the Y-direction horizontal magnetic field is distributed in axial symmetry, and the response values in the Y-axis and the extension direction are much lower than those in other directions. This feature is similar to the X-direction horizontal magnetic field. Based on the complementarity of the magnetic fields in different directions of the horizontal magnetic field, the Y-direction horizontal magnetic field can be observed in the area where the X-direction horizontal magnetic field is weak, thus realizing the full-area detection of the ground-air transient electromagnetic field.

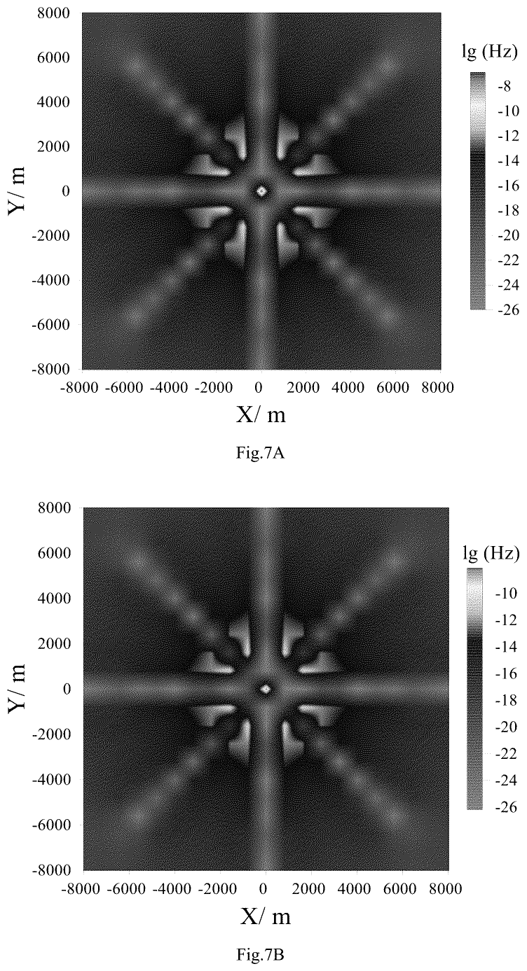

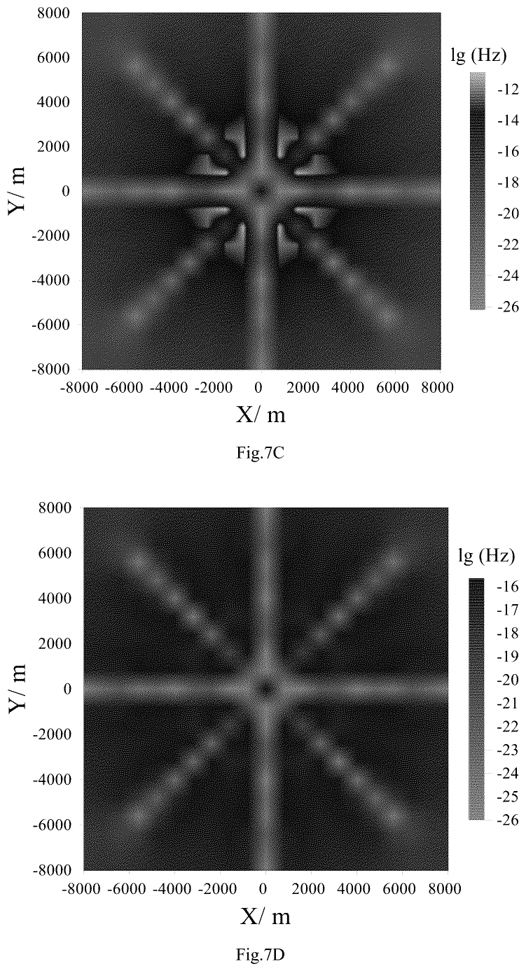

FIGS. 7A-7D show the horizontal magnetic field response distribution in the Z-direction. FIG. 7A corresponds to 10⁻⁵s, FIG. 7B corresponds to 10⁻⁴s, FIG. 7C corresponds to 10⁻³s, and FIG. 7D corresponds to 10⁻²s. As shown in FIGS. 7A-7D, the overall amplitude of the Z-direction horizontal magnetic field is far lower than that of the horizontal magnetic field, and the response value is generally lower than 10-10, which is related to the mutual attenuation of the vertical magnetic field by the reverse current of each line source, and a lower signal-to-noise ratio is not conducive to field data acquisition. Therefore, the field data acquisition of umbrella-shaped source ground-air TEM will be mainly based on horizontal magnetic field.

Next, the analysis of the sensitivity to high-resistance targets will be described. In order to analyze the detection capability of the observed electromagnetic field component to a high-resistance target layer, the abnormal distribution caused by the high-resistance target layer in different regions is analyzed. Error space analysis is introduced to calculate the error distribution between the response data and target layer model data when the resistivity and thickness of the target layer change, so as to analyze the sensitivity of responses of different observation components and different offset ranges to the target layer at the same depth.

In the transient electromagnetic data inversion based on classical optimization, the root mean square error (RMSE) contained in the target function represents the difference between the response generated by a background model and the response generated by a target body model. Therefore, the root mean square error between the background model and the target body model is an important basis for whether a target body can be identified. Firstly, a G-type model is taken as the background model and a K-type model is taken as the target layer model. By analyzing the plane distribution of root mean square error between the response of the target layer model and the response of the background model under the excitation of an electrical source, the optimal observation area is analyzed.

In inversion, the calculation formula of root mean square error is shown in Formula 4.

$${𝓍}_{RM S} = \sqrt{\frac{1}{{N}_{chn}} {\sum }_{j = 1}^{{N}_{chn}} {[ \frac{{d}_{j}^{t} - {d}_{j}^{b}}{{s}_{j}} ]}^{2}} \qquad Formula 4$$

wherein X_{RMIS} represents the root mean square error, d′ⱼ is the value of the target layer model at the j<th> time channel, dⱼ^{b} is the value of the background model at the j<th> time channel, N_{chn} is the number of time channels, and Sⱼ is the standard deviation corresponding to the j<th> time channel data. In simulation calculation, for example, 1% Gaussian noise may be added to the simulation response.

Model parameters are as follows:

$$\begin{matrix}K : \begin{matrix}{ρ}_{1} = 100 Ω \cdot m , & {d}_{1} = 300 m ; {ρ}_{2} = 1000 Ω \cdot m , & {d}_{2} = 100 m ; & {ρ}_{3} = 200 Ω \cdot m\end{matrix} \\ G : \begin{matrix}{ρ}_{1} = 100 Ω \cdot m , & {d}_{1} = 300 m ; {ρ}_{2} = 200 Ω \cdot m ,\end{matrix}\end{matrix}$$

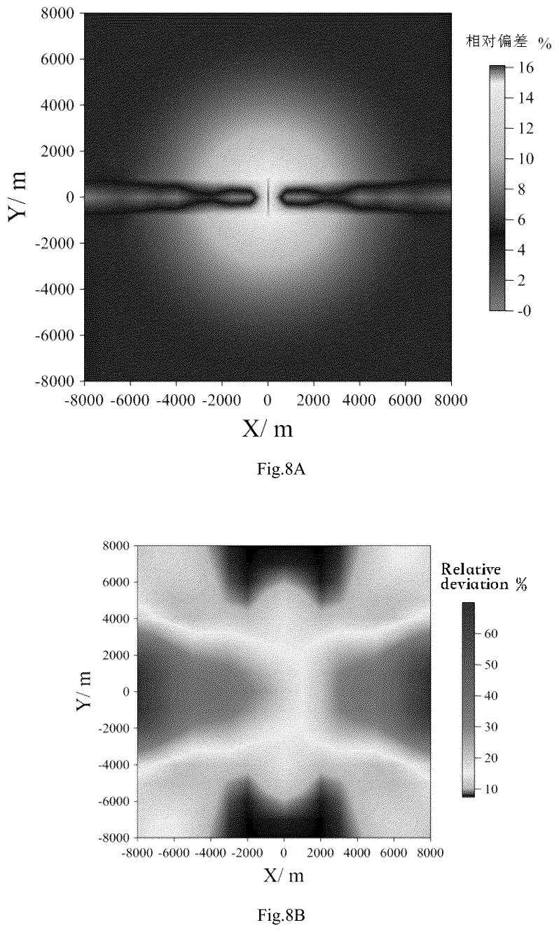

Formulas 11-13 and Formulas 31-33 are used respectively to calculate the responses of the single line source ground-air transient magnetic field and the umbrella-shaped source ground-air transient magnetic field, the response difference between different models is calculated according to Formula 4, and the calculation results are shown in FIGS. 8A and 8B. FIG. 8A shows the root mean square error distribution (K vs G) of the single line source ground-air transient electromagnetic X-horizontal magnetic field to the high-resistance target, and FIG. 8B shows the root mean square error distribution (K vs G) of the umbrella-shaped source ground-air transient electromagnetic X-horizontal magnetic field to the high-resistance target.

As shown in FIGS. 8A and 8B, the maximum root mean square error of the traditional single line source horizontal magnetic field to high resistance is less than 20%, and the value in most areas is less than 10%. The traditional line source has poor sensitivity to high-resistance targets, which is not conducive to the detection of high-resistance targets, and this is related to the fact that the traditional single line source horizontal magnetic field is mainly composed of the transverse polarization field. The umbrella-shaped source horizontal magnetic field has a large root mean square error to high resistance, the value in most areas is more than 30%, and the sensitivity to high-resistance targets is good. The umbrella-shaped source ground-air TEM horizontal magnetic field can be used to detect high-resistance targets. Meanwhile, the umbrella-shaped source is composed of single line sources in different directions, and the extension lines of the line sources in other directions also have the characteristics shown in FIG. 8B, i.e. the extension lines of each line source of the umbrella-shaped source and the adjacent areas thereof have strong sensitivity to high-resistance targets, thus realizing the full-area detection of the high-resistance targets by the umbrella-shaped source ground-air TEM.

The inversion process of umbrella-shaped source ground-air transient electromagnetic data in this embodiment is described below.

For high-resistance targets, the regularization problem is solved by introducing a smoothing factor into the target function, which has good convergence stability and does not depend on the initial model

The target function for data inversion is shown in Formula 5.

$$U = {‖ \partial m ‖}^{2} + {μ}^{- 1} \{ {‖ {W}_{d} d - {W}_{d} F ( m ) ‖}^{2} - {χ}_{*}^{2} \} \qquad Formula 5$$

wherein m=(m₁, m₂, . . . m_{N}) is a model vector, m₁˜m_{N} are model parameters in the model vector, N is the number of models, d=(d₁,d₂, . . . ,d_{M}) is a data vector, d₁-d_{M} are specific data in the data vector, M is the number of data, F is a positive operator, x_{*} is a target fitting residual, ∂ is a roughness matrix, Wd=diag(σ₁⁻¹,σ₂⁻¹, . . . ,σ_{M}⁻¹) is an error weighting matrix, σ₁⁻¹˜σ_{M}⁻¹ are errors corresponding to the data respectively, and μ is a Lagrange multiplier, and is used for roughness and target fitting residual.

According to Taylor's theorem and the idea of local linearization, a nonlinear problem can be converted into a linear problem, as shown in Formula 6.

$$F ( {m}^{k} + Δ m ) \approx F ( {m}^{k} ) + J ( {m}^{k} ) Δ m \qquad Formula 6$$

wherein m^{k}+Δm=m^{k+1}, and J(m^{k}) is a Jacobian matrix as shown in Formula 7. K represents the current iteration number, m^{k} represents the current model vector, and Δm represents the model disturbance.

$$J ( {m}^{k} ) = [ \begin{matrix}\frac{\partial {F}_{1} ( {m}^{k} )}{\partial {m}_{1}} & … & \frac{\partial {F}_{1} ( {m}^{k} )}{\partial {m}_{n}} \\ ⋮ & ⋱ & ⋮ \\ \frac{\partial {F}_{m} ( {m}^{k} )}{\partial {m}_{1}} & … & \frac{\partial {F}_{m} ( {m}^{k} )}{\partial {m}_{n}}\end{matrix} ] \qquad Formula 7$$

In Formula 7, F₁(m^{k}), F₂(m^{k}), . . . , Fₘ(m^{k}) respectively represent positive operators of different time channels.

The regularization least squares problem can be solved by Formula 8.

$${m}_{k + 1} ( μ ) = {[ μ {\partial }^{T} \partial + {( {WJ}_{k} )}^{T} {WJ}_{k} ]}^{- 1} {( {WJ}_{k} )}^{T} W {\hat{d}}_{k} . \qquad Formula 8$$

wherein \hat{d}ₖ=d−F(mₖ)+Jₖmₖ.

It should be noted that mk is m^{k}, mₖ₊₁ is m^{k+1}, Jₖ is J(m^{k}), and W is an error weighting matrix (i.e., a diagonal matrix composed of standard deviations of data).

The fitting residual is reduced by linearization search of u; and when the fitting residual is less than a target value, model roughness is introduced to finally obtain a smoothest model.

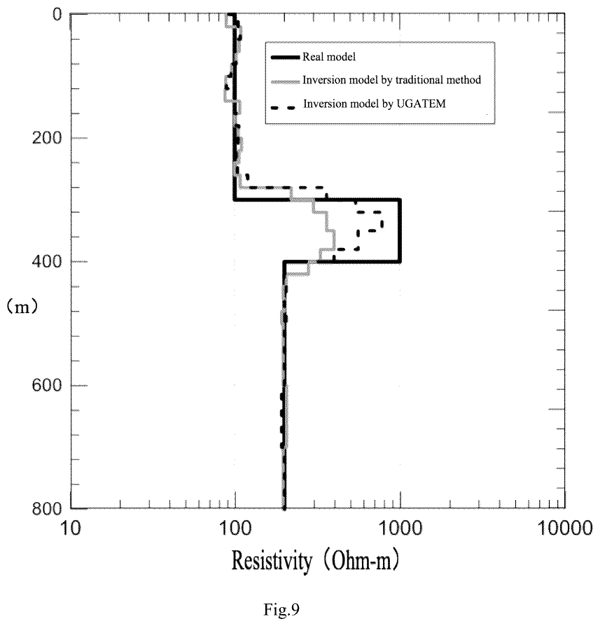

FIG. 9 shows the inversion results of the traditional method and umbrella-shaped source ground-air TEM on a high-resistivity layer model. The inversion results based on the umbrella-shaped source ground-air TEM horizontal magnetic field are closer to the real model and have better display on the value and thickness of a high-resistivity layer.

It should be noted that although several units, modules or sub-modules of the above system are mentioned in the above detailed description, this division is merely exemplary and not mandatory. In fact, according to embodiments of the present invention, the features and functions of two or more modules described above may be embodied in one module. On the contrary, the features and functions of one module described above can be further divided into being embodied by a plurality of modules.

Furthermore, although the operations of the method of the present invention are described in a specific order in the drawings, this does not require or imply that these operations must be performed in this specific order or that all of the operations shown must be performed to achieve the desired results. Additionally or alternatively, certain steps may be omitted, multiple steps may be combined into one step for execution, and/or one step may be decomposed into multiple steps for execution. Although the spirit and principles of the present invention have been described with reference to several specific embodiments, it should be understood that the present invention is not limited to the specific embodiments disclosed, and the division of various aspects does not mean that the features in these aspects cannot be combined to benefit, and such division is only for convenience of expression. The present invention is intended to cover various modifications and equivalent arrangements included within the spirit and scope of the appended claims.

1. A ground-air TEM transverse magnetic polarization field detection method, characterized in that the ground-air TEM transverse magnetic polarization field detection method comprises:
adopting an umbrella-shaped source as a ground emission source, wherein the umbrella-shaped source is an emission source device comprising a plurality of emission line sources, the lengths of the emission line sources are the same, one end of each emission line source is connected to the center of the umbrella-shaped source, the emission line sources are arranged in an umbrella rib mode, current directions diverge outwards from the center along each emission line source, and included angles between adjacent emission line sources are identical; and
using the umbrella-shaped source to detect a ground-air transient electromagnetic field, and obtaining the horizontal magnetic field component data of the umbrella-shaped source, thus realizing the observation of a ground-air TEM transverse magnetic polarization field.

2. The ground-air TEM transverse magnetic polarization field detection method according to claim 1, characterized in that the ground-air TEM transverse magnetic polarization field detection method further comprises:
performing data inversion by using the horizontal magnetic field component data of the umbrella-shaped source, and identifying underground high-resistance target information according to the data inversion result.

3. The ground-air TEM transverse magnetic polarization field detection method according to claim 2, characterized in that the step of performing data inversion by using the horizontal magnetic field component data of the umbrella-shaped source comprises using the following function as the target function for data inversion:
$$U = {‖ \partial m ‖}^{2} + {μ}^{- 1} \{ {‖ {W}_{d} d - {W}_{d} F ( m ) ‖}^{2} - {χ}_{*}^{2} \} ,$$
wherein m=(m₁, m₂, . . . m_{N}) d=(d₁,d₂ . . . , d_{M}) is a model vector, m₁˜m_{N} are model parameters in the model vector, N is the number of models, d=(d₁, d₂, . . . d_{M}) is a data vector, d₁-d_{M} are specific data in the data vector, M is the number of data, F is a positive operator, is a target fitting residual, ∂ is a roughness matrix, W_{d}=diag(σ₁⁻¹, σ₂⁻¹, . . . ,σ_{M}⁻¹) is an error weighting matrix, σ₁⁻¹˜σ_{M}⁻¹ are errors corresponding to the data respectively, and μ is a Lagrange multiplier, and is used for roughness and target fitting residual;
according to Taylor's theorem and the idea of local linearization, converting a nonlinear problem into a linear problem according to the following formula:
$$F ( {m}^{k} + Δ m ) \approx F ( {m}^{k} ) + J ( {m}^{k} ) Δ m ;$$
wherein m^{k}+Δm=m^{k+1}, and J(m^{k}) is a Jacobian matrix;
solving the regularization least squares problem by the following formula:
$${m}_{k + 1} ( μ ) = {[ μ {\partial }^{T} \partial + {( {WJ}_{k} )}^{T} {WJ}_{k} ]}^{- 1} {( {WJ}_{k} )}^{T} W {\hat{d}}_{k} ;$$
wherein \hat{d}ₖ=d−F(mₖ)+Jₖmₖ,
reducing the fitting residual by linearization search of u; and when the fitting residual is less than a target value, introducing model roughness to finally obtain a smoothest model.

4. The ground-air TEM transverse magnetic polarization field detection method according to any one of claim 1, characterized in that the best observation area for umbrella-shaped source ground-air transient electromagnetic field data is a horizontal magnetic field.

5. A ground-air TEM transverse magnetic polarization field detection system, the ground-air TEM transverse magnetic polarization field detection system comprising a ground emission source, characterized in that:
the ground emission source is an umbrella-shaped source, wherein the umbrella-shaped source is an emission source device comprising a plurality of emission line sources, the lengths of the emission line sources are the same, one end of each emission line source is connected to the center of the umbrella-shaped source, the emission line sources are arranged in an umbrella rib mode, current directions diverge outwards from the center along each emission line source, and included angles between adjacent emission line sources are identical;
and the ground-air TEM transverse magnetic polarization field detection system further comprises a processing unit, and the processing unit is suitable for realizing observation of a ground-air TEM transverse magnetic polarization field based on the horizontal magnetic field component data of the umbrella-shaped source when the umbrella-shaped source is used for detecting a ground-air transient electromagnetic field.

6. The ground-air TEM transverse magnetic polarization field detection system according to claim 1, characterized in that the processing unit is further suitable for:
performing data inversion by using the horizontal magnetic field component data of the umbrella-shaped source, and identifying underground high-resistance target information according to the data inversion result.

7. The ground-air TEM transverse magnetic polarization field detection system according to claim 2, characterized in that the processing unit is suitable for using the following function as the target function for data inversion:
$$U = {‖ \partial m ‖}^{2} + {μ}^{- 1} \{ {‖ {W}_{d} d - {W}_{d} F ( m ) ‖}^{2} - {χ}_{*}^{2} \} ,$$
wherein m=(m₁, m₂, . . . m_{N}) d=(d₁,d₂, . . . ,d_{M}) is a model vector, m₁˜m_{N} are model parameters in the model vector, N is the number of models, d=(d₁,d₂, . . . ,d_{M}) is a data vector, d₁-d_{M} are specific data in the data vector, M is the number of data, F is a positive operator, X_{*} is a target fitting residual, ∂ is a roughness matrix, W_{d}=diag(σ₁⁻¹,σ₂⁻¹, . . . ,σ_{M}⁻¹) is an error weighting matrix, σ₁⁻¹˜σ_{M}⁻¹ are errors corresponding to the data respectively, and μ is a Lagrange multiplier, and is used for roughness and target fitting residual;
according to Taylor's theorem and the idea of local linearization, converting a nonlinear problem into a linear problem according to the following formula:
$$F ( {m}^{k} + Δ m ) \approx F ( {m}^{k} ) + J ( {m}^{k} ) Δ m ;$$
wherein m^{k}+Δm=m^{k+1}, and J(m^{k}) is a Jacobian matrix;
solving the regularization least squares problem by the following formula:
$${m}_{k + 1} ( μ ) = {[ μ {\partial }^{T} \partial + {( {WJ}_{k} )}^{T} {WJ}_{k} ]}^{- 1} {( {WJ}_{k} )}^{T} W {\hat{d}}_{k} ;$$
wherein \hat{d}ₖ=d−F(mₖ)+Jₖmₖ;
reducing the fitting residual by linearization search of u; and when the fitting residual is less than a target value, introducing model roughness to finally obtain a smoothest model.

8. The ground-air TEM transverse magnetic polarization field detection system according to any one of claim 1, characterized in that the best observation area for umbrella-shaped source ground-air transient electromagnetic field data is a horizontal magnetic field.
